(19) United States
(12) Patent Application Publication
(10) Pub. No.: US 2007/0045053 A1
(43) Pub. Date: Mar. 1, 2007

(54) Elevator apparatus

(75) Inventor: Naoki Hashiguchi, Tokyo (JP)

Correspondence Address: BUCHANAN, INGERSOLL & ROONEY PC, POST OFFICE BOX 1404, ALEXANDRIA, VA, 22313-1404, US

(73) Assignee: MITSUBISHI DENKI KABUSHIKI KAISHA, Tokyo (JP)

(21) Appl. No.: 10/562,054

(22) PCT Filed: Apr. 28, 2004
(86) PCT No.: PCT/JP04/06173

§ 371 Date: Dec. 23, 2005

(51) Int. Cl. B66B 7/02

(52) U.S. Cl. 187/408

(57) ABSTRACT

In an elevator apparatus, a car guide rail for guiding a car when the car is raised and lowered is installed within a hoistway. The car is mounted with a car guide shoe for engaging with the car guide rail. On a vertical projection plane, a recess is provided in a wall portion of the car, and the car guide shoe is at least partially disposed in the recess.

### TECHNICAL FIELD

The present invention relates to an elevator apparatus having a structure in which a car guide rail for guiding a car when it is raised and lowered is installed within a hoistway.

### BACKGROUND ART

For example, in a conventional elevator apparatus disclosed in JP 9-165163 A, a car guide rail is disposed in a space between a car and a wall of a hoistway. Further, a counterweight is disposed in a space behind the car guide rail within the hoistway. Moreover, a hoisting machine is disposed in a space in front of the car guide rail within the hoistway.

In the conventional elevator apparatus, however, a space for disposing the car guide rail between the car and the wall of the hoistway needs to be secured. This entails an increase in the space for the hoistway.

To this end, according to one aspect of the present invention, there is provided an elevator apparatus comprising: a car having a wall portion, for being raised and lowered within a hoistway;

a car guide rail installed within the hoistway, for guiding the car when the car is raised and lowered; and a car guide shoe mounted on the car, for engaging with the car guide rail, wherein the wall portion is provided with a recess, and the car guide shoe is at least partially disposed in the recess on a vertical projection plane.

According to another aspect of the present invention, there is provided an elevator apparatus comprising: a drive device having a drive sheave; a first main rope and a second main rope wound around the drive sheave; a car having a first rope connecting portion to which the first main rope is connected and a second rope connecting portion to which the second main rope is connected, for being raised and lowered within a hoistway through a driving force of the drive device; and a first car guide rail and a second car guide rail installed within the hoistway, for guiding the car when the car is raised and lowered, wherein the first car guide rail and the second car guide rail have a pitch between car guide rail rear faces which is set equal to or smaller than a car suspension pitch defined by the first main rope and the second main rope, in a width direction of the car.

According to a still further aspect of the present invention, there is provided an elevator apparatus comprising: a car for being raised and lowered within a hoistway; a pair of car guide rails installed within the hoistway, for guiding the car when the car is raised and lowered; and a plurality of car guide shoes installed in the car, for engaging with the car guide rails wherein: the car has chamfered portions facing each other, the chamfered portions being formed at diagonally located corner portions of the car; the car guide rails are installed to face the chamfered portions respectively; and the car guide shoes are disposed in the chamfered portions respectively.

According to a still further aspect of the present invention, there is provided an elevator apparatus comprising: a car having a wall portion, for being raised and lowered within a hoistway;

a car guide rail installed within the hoistway, for guiding the car when the car is raised and lowered; and an safety device installed in the car, for engaging with the car guide rail to stop the car as an emergency measure, wherein the wall portion is provided with a recess, and the safety device is at least partially disposed in the recess on a vertical projection plane.

### DISCLOSURE OF THE INVENTION

The present invention is made to solve the problem as mentioned above, and has an object of providing an elevator apparatus enabling a further reduction in the space for a hoistway.

An elevator apparatus according to the present invention includes: a car having a wall portion, for being raised and lowered within a hoistway; a car guide rail installed within the hoistway, for guiding the car when the car is raised and lowered; and a car guide shoe mounted on the car, for engaging with the car guide rail. The wall portion is provided with a recess, and the car guide shoe is at least partially disposed in the recess on a vertical projection plane.

An elevator apparatus according to the present invention includes: a drive device having a drive sheave; a first main rope and a second main rope which are wound around the drive sheave; a car having a first rope connecting portion to which the first main rope is connected and a second rope connecting portion to which the second main rope is connected, for being raised and lowered within a hoistway through a driving force of the drive device; and a first car guide rail and a second car guide rail which are installed within the hoistway, for guiding the car when the car is raised and lowered. The first car guide rail and the second car guide rail have a dimension between car guide rail rear faces which is set equal to or smaller than a dimension between the first main rope and the second main rope, and the first rope connecting portion and the second rope connecting portion, in a width direction of the car.

Further, in an elevator apparatus according to the present invention, which includes: a car for being raised and lowered within a hoistway; a pair of car guide rails installed within the hoistway, for guiding the car when the car is raised and lowered; and a plurality of car guide shoes installed in the car, for engaging with the car guide rails, the car has chamfered portions facing each other, the chamfered portions being formed at diagonally located corner portions of the car, the car guide rails are installed so as to face the chamfered portions, and the car guide shoes are disposed in the chamfered portions.

Furthermore, an elevator apparatus according to the present invention includes: a car having a wall portion, for being raised and lowered within a hoistway; a car guide rail installed within the hoistway, for guiding the car when the car is raised and lowered; and an safety device installed in the car, for engaging with the car guide rail to stop the car as an emergency measure. The wall portion is provided with a recess, and the safety device is at least partially disposed in the recess on a vertical projection plane.

### BRIEF DESCRIPTION OF DRAWINGS

FIG. 1 is a plan view showing an elevator apparatus according to Embodiment 1 of the present invention;

FIG. 2 is a plan view showing an essential part of FIG. 1 in an enlarged manner;

FIG. 3 is a side view showing the elevator apparatus of FIG. 1;

FIG. 4 is a perspective view showing an safety device of FIG. 3;

FIG. 5 is a plan view showing the safety device of FIG. 4;

FIG. 6 is a plan view showing an elevator apparatus according to Embodiment 2 of the present invention;

FIG. 7 is a plan view showing an essential part of FIG. 6 in an enlarged manner;

FIG. 8 is a side view showing the elevator apparatus of FIG. 6;

FIG. 9 is a plan view showing an safety device of the elevator apparatus of FIG. 6;

FIG. 10 is a plan view showing an elevator apparatus according to Embodiment 3 of the present invention;

FIG. 11 is a plan view showing an elevator apparatus according to Embodiment 4 of the present invention;

FIG. 12 is a plan view showing the elevator apparatus of FIG. 11 in its door-open state;

FIG. 13 is a plan view showing an elevator apparatus according to Embodiment 5 of the present invention;

FIG. 14 is a plan view showing an elevator apparatus according to Embodiment 6 of the present invention;

FIG. 15 is a plan view showing an essential part of FIG. 14 in an enlarged manner;

FIG. 16 is a side view showing the elevator apparatus of FIG. 14;

FIG. 17 is a plan view showing an elevator apparatus according to Embodiment 7 of the present invention;

FIG. 18 is a side view showing the elevator apparatus of FIG. 17;

FIG. 19 is a plan view showing an elevator apparatus according to Embodiment 8 of the present invention;

FIG. 20 is a side view showing the elevator apparatus of FIG. 19;

FIG. 21 is a plan view showing an elevator apparatus according to Embodiment 9 of the present invention;

FIG. 22 is a plan view showing an elevator apparatus according to Embodiment 10 of the present invention;

FIG. 23 is a plan view showing an elevator apparatus according to Embodiment 11 of the present invention;

FIG. 24 is a side view showing the elevator apparatus of FIG. 23;

FIG. 25 is a plan view showing an elevator apparatus according to Embodiment 12 of the present invention; and

FIG. 26 is a side view showing the elevator apparatus of FIG. 25.

### BEST MODES FOR CARRYING OUT THE INVENTION

Preferred embodiments of the present invention will be described hereinafter with reference to the drawings.

### Embodiment 1

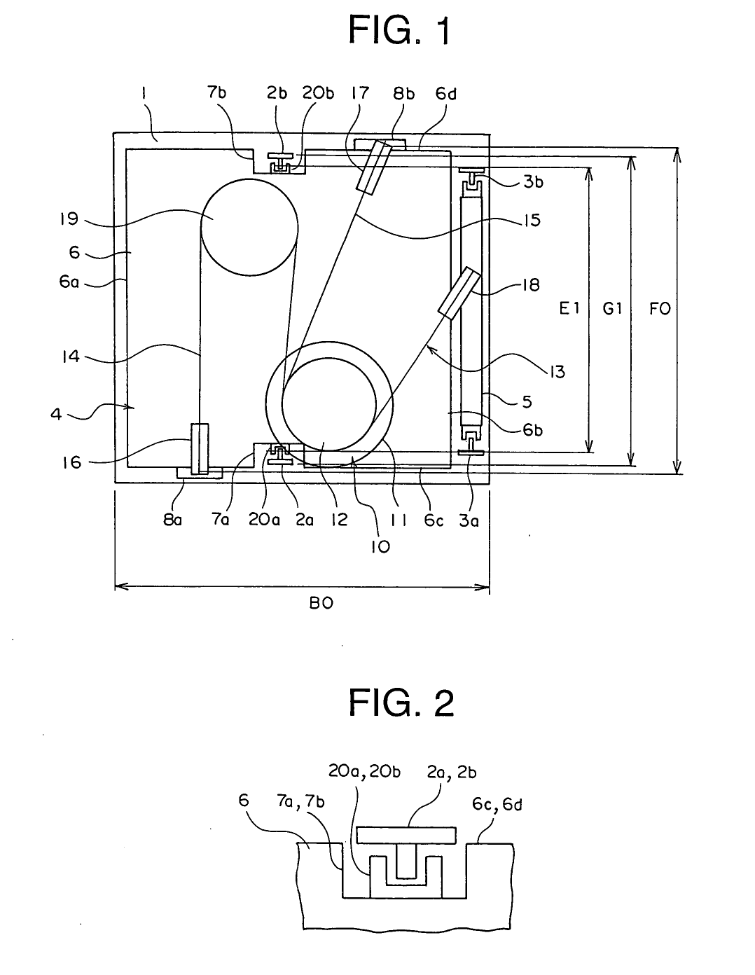

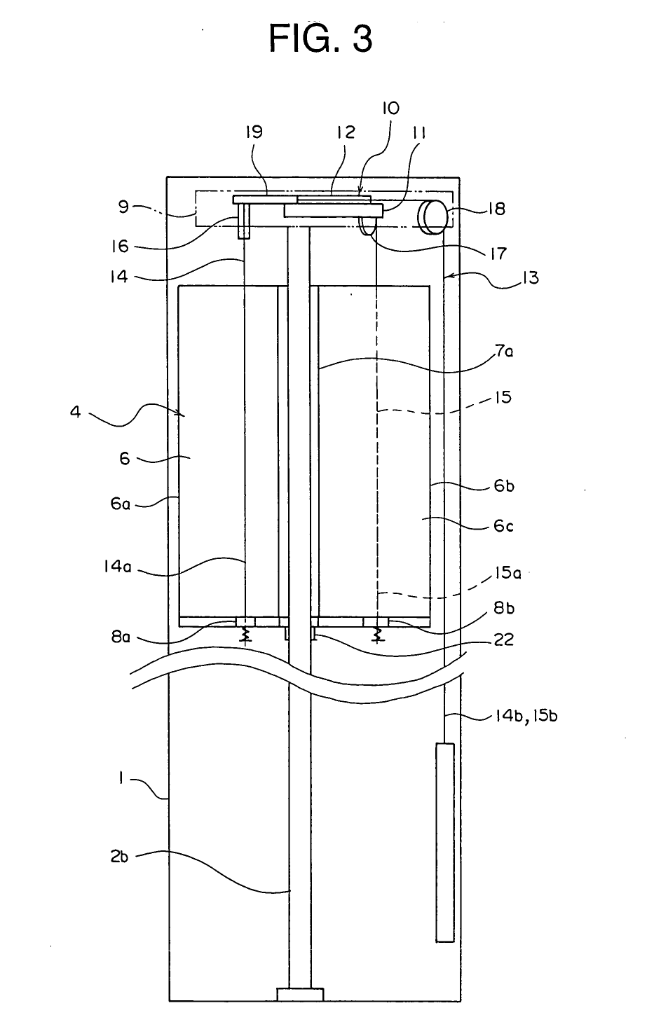

FIG. 1 is a plan view showing an elevator apparatus (a machine-room-less elevator) according to Embodiment 1 of the present invention. FIG. 2 is a plan view showing an essential part of FIG. 1 in an enlarged manner. FIG. 3 is a side view showing the elevator apparatus of FIG. 1.

Referring to the figures, first and second car guide rails 2a and 2b and first and second counterweight guide rails 3a and 3b are installed within a hoistway 1. Each of the guide rails 2a, 2b, 3a, and 3b has a T-shaped cross-section. A car 4 is raised and lowered within the hoistway 1 while being guided by the car guide rails 2a and 2b. A counterweight 5 is raised and lowered within the hoistway 1 while being guided by the counterweight guide rails 3a and 3b.

The car 4 has a car frame (not shown) and a cage 6 supported by the car frame. The cage 6 has a floor portion, a wall portion, and a ceiling portion. The wall portion of the cage 6 has a front face 6a provided with a car entrance (not shown), a rear face 6b facing the front face, a first side face 6c, and a second side face 6d facing the first side face.

On a vertical projection plane, the first side face 6c is provided with a first recess 7a, and the second side face 6d is provided with a second recess 7b. The first and second recesses 7a and 7b are continuously provided along a direction in which the car 4 is raised and lowered (vertical direction). In other words, the first and second recesses 7a and 7b are formed like grooves.

By providing the first and second recesses 7a and 7b, a few slight projections are formed in the cage 6. However, these projections are not large enough to affect the passenger capacity of the elevator apparatus.

A first car guide shoe 20a engaging the first car guide rail 2a is at least partially disposed in the first recess 7a. A second car guide shoe 20b engaging the second car guide rail 2b is at least partially disposed in the second recess 7b. In this example, the car guide shoes 20a and 20b are entirely accommodated in the recesses 7a and 7b respectively.

Thus, the dimension between the car guide shoes 20a and 20b is smaller than the dimension between the first and second side faces 6c and 6d, except the dimension between the recesses 7a and 7b.

The car guide shoes 20a and 20b are not particularly limited in type. For instance, sliding guide shoes, roller guide shoes, magnetic guide shoes, or the like can be used. It is desirable that 80% or more of the car guide shoes 20a and 20b be accommodated within the recesses 7a and 7b as seen in their cross-sections, respectively.

Further, on the vertical projection plane, the car guide rails 2a and 2b are at least partially disposed within the recesses 7a and 7b respectively. The car guide rails 2a and 2b are disposed facing the recesses 7a and 7b respectively.

The first and second recesses 7a and 7b are provided at the same position in the depth direction of the cage 6. The car guide rails 2a and 2b face each other. In other words, on the vertical projection plane, centerlines of the car guide rails 2a and 2b are parallel to each other and located on the same straight line.

When the counterweight 5 is located at the same height as the car 4, it is disposed behind the car 4 so as to face the rear face 6b.

First and second rope connecting portions 8a and 8b are provided in a lower portion of the car 4. The first and second rope connecting portions 8a and 8b slightly project from the first and second side faces 6c and 6d respectively on the vertical projection plane. Further, on the vertical projection plane, the first and second rope connecting portions 8a and 8b are disposed symmetrically or substantially symmetrically with respect to the center of gravity of the car 4.

In addition, the first rope connecting portion 8a is disposed in front of the first car guide rail 2a in the depth direction of the car 4. The second rope connecting portion 8b is disposed behind the second car guide rail 2b in the depth direction of the car 4.

A support frame 9 (FIG. 3) is installed in an upper portion of the hoistway 1. The support frame 9 is at least partially supported by the car guide rails 2a and 2b and the counterweight guide rails 3a and 3b. Alternatively, the support frame 9 may be supported by a support portion provided to a building.

The support frame 9 supports a drive device (hoisting machine) 10 that generates a driving force for raising and lowering the car 4 and the counterweight 5. The drive device 10 has a drive device main body 11 including a motor and a brake, and a drive sheave 12 rotated by the drive device main body 11.

In this example, the drive sheave 12 is disposed on the drive device main body 11. Further, the drive sheave 12 is directly driven by the motor of the drive device main body 11 without the intervention of a decelerating mechanism.

Further, the drive device 10 is disposed horizontally (or substantially horizontally) such that a rotating shaft of the drive sheave 12 extends vertically (or substantially vertically). Employed as the drive device 10 is a thin hoisting machine having an axial dimension that is smaller than an outer diameter dimension in a direction perpendicular to the axial direction.

Moreover, the drive device 10 entirely or substantially entirely overlap the car 4 on the vertical projection plane. In other words, the drive device 10 is disposed directly above the car 4.

A main rope group 13 for suspending the car 4 and the counterweight 5 within the hoistway 1 is wound around the drive sheave 12. The main rope group 13 includes a plurality of first main ropes 14 (only one of which is shown in the figure) and a plurality of second main ropes 15 (only one of which is shown in the figure)

The car 4 and the counterweight 5 are suspended according to a 1:1 roping method by means of the main rope group 13.

Each first main rope 14 has a first end portion 14a connected to the first rope connecting portion 8a, and a second end portion 14b connected to an upper portion of the counterweight 5. Each second main rope 15 has a third end portion 15a connected to the second rope connecting portion 8b, and a fourth end portion 15b connected to the upper portion of the counterweight 5.

A first pulley 16 for guiding the first main rope 14 to the first rope connecting portion 8a, a second pulley 17 for guiding the second main rope 15 to the second rope connecting portion 8b, a third pulley 18 for guiding the first and second main ropes 14 and 15 to the counterweight 5, and a deflection pulley 19 for guiding the first main rope 14 extending from the drive sheave 12 to the first pulley 16 are mounted on the support frame 9.

The first pulley 16 is disposed directly above the first rope connecting portion 8a. The second pulley 17 is disposed directly above the second rope connecting portion 8b.

The first to third pulleys 16 to 18 are disposed such that their rotating shafts extend horizontally. The deflection pulley 19 is disposed such that its rotating shaft extends vertically (or substantially vertically).

The drive device 10 and the pulleys 16 to 19 are mounted on the common support frame 9 and unitized.

If it is assumed that F0 denotes an inter-car suspension pitch (a dimension between the first end portion 14a and the third end portion 15a in the width direction of the car 4), that G1 denotes an inter-car guide rail rear face pitch (a dimension between the rear faces of the car guide rails 2a and 2b in the width direction of the car 4), and that E1 denotes an inter-guide shoe pitch (a dimension between the car guide shoes 20a and 20b in the width direction of the car 4), it follows that F0≧G1>E1.

An safety device 22 for bringing the car 4 to an emergency stop when the elevator undergoes an abnormality such as an overspeed is mounted on a lower portion of the car 4. The safety device 22 may be a mechanical device operating through the transmission of a mechanical operating force or an electric device having an actuator that operates in response to an electric actuation signal.

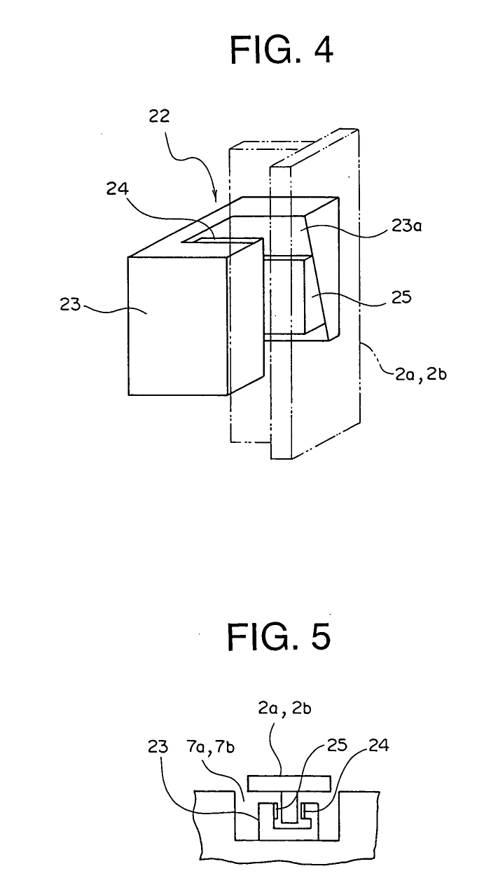

FIG. 4 is a perspective view showing the safety device 22 of FIG. 3. FIG. 5 is a plan view showing the safety device 22 of FIG. 4. The safety device 22 has a fixed piece 23 fixed to the car 4 side, a fixed-side braking piece 24 fixed inside the fixed piece 23, and a movable-side braking piece (wedge member) 25 slidably provided inside the fixed piece 23.

The fixed-side braking piece 24 is so fixed to the fixed piece 23 as to face a side face of the car guide rail 2a or 2b. A tapered slide guide face 23a is provided on the fixed piece 23 along its joint face with the movable-side braking piece 25.

When the safety device 22 is in operation, the movable-side braking piece 25 is displaced upwards with respect to the car 4 along the slide guide face 23a. The movable-side braking piece 25 is thereby wedged in between the slide guide face 23a and the side face of the car guide rail 2a or 2b, so that the car guide rail 2a or 2b is sandwiched between the fixed-side braking piece 24 and the movable-side braking piece 25. As a result, the car 4 is stopped as an emergency measure.

On the vertical projection plane, the safety device 22 is at least partially disposed in the recesses 7a and 7b. In this example, the safety device 22 has an engaging portion for engaging the car guide rails 2a and 2b, and this engaging portion is entirely accommodated in the recesses 7a and 7b.

In the elevator apparatus constructed as described above, since the car guide shoes 20a and 20b and the car guide rails 2a and 2b are disposed in the recesses 21a and 21b provided in the cage 6, the installation space for the elevator apparatus in the width direction of the car 4 can be reduced. As a result, the space for the hoistway can further be reduced.

Furthermore, since F0≧G1, the space for the hoistway can be more effectively reduced. By the same token, since F0>E1, the space for the hoistway can be more effectively reduced.

In particular, if a decrease in the cross-sectional area of the hoistway 1 resulting from the provision of the recesses 7a and 7b is larger than a decrease in the cross-sectional area of the cage 6 resulting from the provision of the recesses 7a and 7b, the space for the hoistway can be more effectively reduced.

Further, since the safety device 22 is at least partially disposed in the recesses 7a and 7b, the safety device 22 can be prevented from protruding from the car 4, so that the installation space for the elevator apparatus in the width direction of the car 4 can be reduced. As a result, the space for the hoistway can further be reduced.

In Embodiment 1, the car guide rails 2a and 2b are disposed at the same position in the depth direction of the car 4. However, the car guide rails may be disposed offset from each other in the depth direction of the car 4.

### Embodiment 2

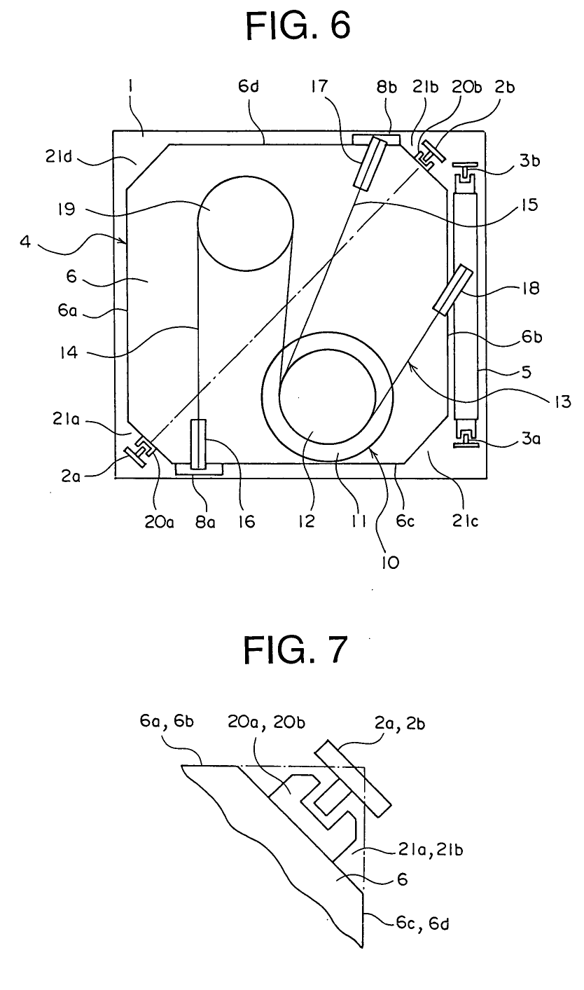

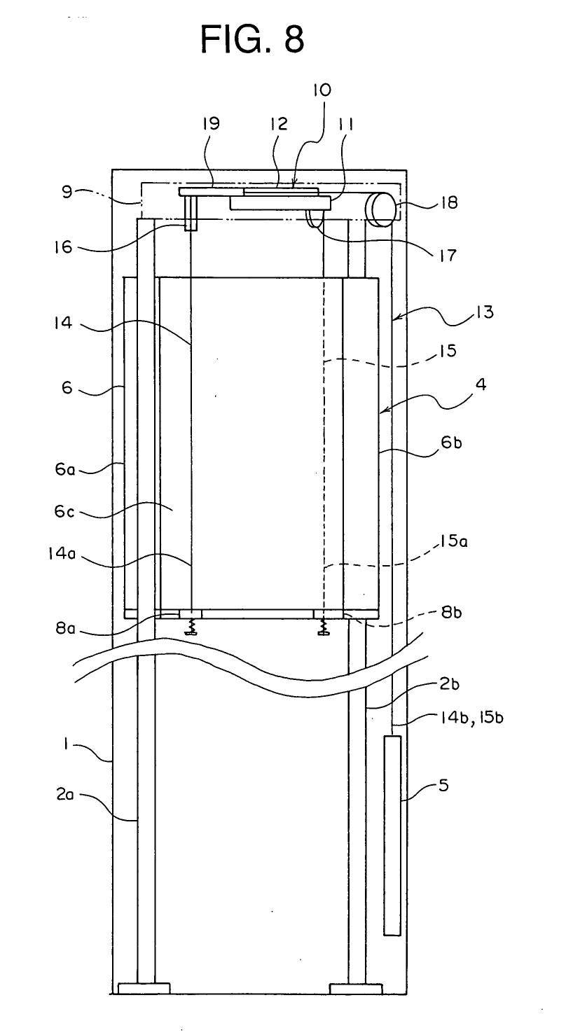

Next, FIG. 6 is a plan view showing an elevator apparatus (machine-room-less elevator) according to Embodiment 2 of the present invention. FIG. 7 is a plan view showing an essential part of FIG. 6 in an enlarged manner. FIG. 8 is a side view showing the elevator apparatus of FIG. 6.

Referring to the figures, a first recess 21a is provided in a corner portion between the front face 6a and the first side face 6c of the cage 6. A second recess 21b is provided in a corner portion between the rear face 6b and the second side face 6d of the cage 6. A third recess 21c is provided in a corner portion between the rear face 6b and the first side face 6c of the cage 6. A fourth recess 21d is provided in a corner portion between the front face 6a and the second side face 6d of the cage 6.

The recesses 21a to 21d are so formed as to chamfer the four corners of the rectangular cage 6 on the vertical projection plane. In other words, the recesses 21a to 21d can also be referred to as chamfered portions, notched corner portions, or notched cross-section portions. The first recess 21a and the second recess 21b are parallel or substantially parallel to each other. A bottom face (chamfered face) of the third recess 21c and a bottom face of the fourth recess 21d are parallel or substantially parallel to each other.

The recesses 21a to 21d are continuously provided along the direction in which the car 4 is raised and lowered (vertical direction).

The first car guide shoe 20a engaging the first car guide rail 2a is at least partially disposed in the first recess 21a. The second car guide shoe 20b engaging the second car guide rail 2b is at least partially disposed in the second recess 21b. In this example, the car guide shoes 20a and 20b are entirely accommodated in the recesses 21a and 21b respectively.

In other words, as shown in FIG. 7, the first car guide shoe 20a is disposed substantially inside a triangular area (within the first recess 21a) that is surrounded by an extended straight line of the front face 6a, an extended straight line of the first side face 6c, and the bottom face of the first recess 21a, on the vertical projection plane. Further, the second car guide shoe 20b is substantially disposed inside a triangular area (within the second recess 21b) that is surrounded by an extended straight line of the rear face 6b, an extended straight line of the second side face 6d, and the bottom face of the second recess 21b, on the vertical projection plane.

It is desirable that the car guide shoes 20a and 20b be so disposed as to be accommodated in the recesses 21a and 21b respectively by 80% or more as seen in their cross-sections.

Further, on the vertical projection plane, the car guide rails 2a and 2b are at least partially disposed in the recesses 21a and 21b respectively. The car guide rails 2a and 2b, which face each other, face the bottom faces of the first and second recesses 21a and 21b respectively. In other words, on the vertical projection plane, the centerlines of the car guide rails 2a and 2b are parallel to each other and located on the same straight line (a diagonal line of the cage 6).

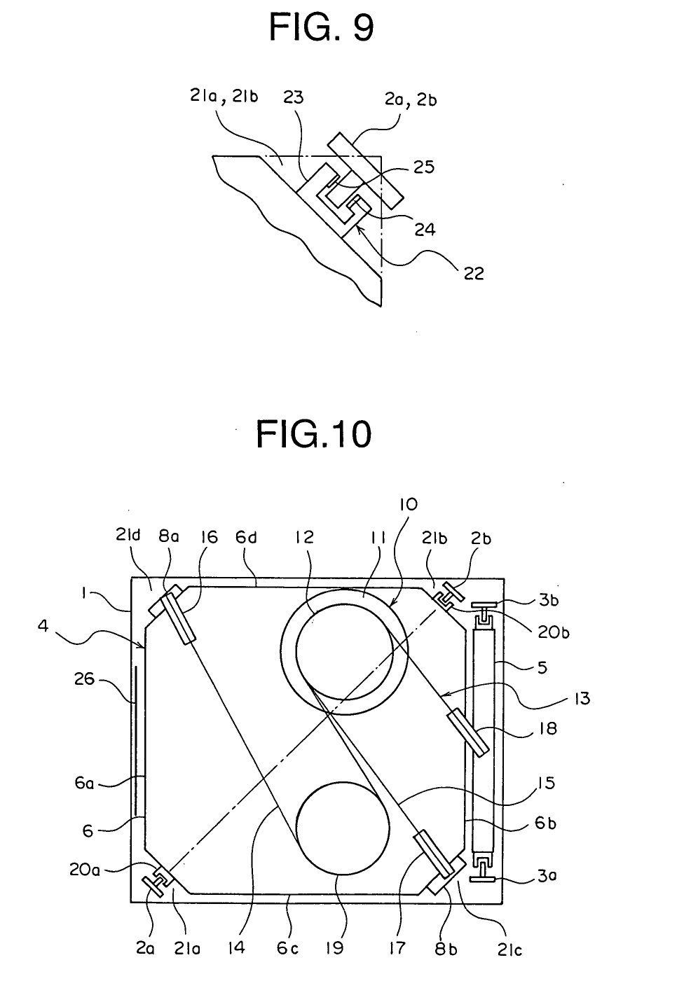

As shown in FIG. 9, on the vertical projection plane, the safety device 22 is at least partially disposed in the recesses 21a and 21b. In this example, the safety device 22 has an engaging portion for engaging the car guide rails 2a and 2b, and this engaging portion is entirely accommodated in the recesses 21a and 21b.

Embodiment 2 is substantially the same as Embodiment 1 in other constructional details.

In the elevator apparatus constructed as described above, since the car guide shoes 20a and 20b and the car guide rails 2a and 2b are disposed in the recesses 21a and 21b provided in the cage 6, the installation space for the elevator apparatus in the width direction of the car 4 can be reduced. As a result, the space for the hoistway can further be reduced.

Further, since the car guide shoes 20a and 20b and the car guide rails 2a and 2b are disposed at diagonal positions of the car 4, the clearance between the car guide rails 2a and 2b can be widened, so that vibrations around a vertical axis of the traveling car 4 are suppressed. As a result, the car 4 can be stably raised and lowered. Thus, relatively inexpensive sliding guide shoes or the like can be employed as the car guide shoes 20a and 20b, so that cost reduction is made possible.

In addition, the recesses 21a to 21d are provided in the respective four corners of the cage 6. Therefore, even when the car 4 and the counterweight 5 pass each other within the narrow hoistway 1, air can be let out through the recesses 21a to 21d. As a result, the generation of impact noise or vibrations at the time when they pass each other can be suppressed.

Furthermore, since the safety device 22 is at least partially disposed in the recesses 21a and 21b, it can be prevented from protruding from the car 4. This makes it possible to reduce the installation space for the elevator apparatus in the width direction of the car 4 and further reduce the space for the hoistway.

### Embodiment 3

Next, FIG. 10 is a plan view showing an elevator apparatus according to Embodiment 3 of the present invention. Referring to the figure, the first and second rope connecting portions 8a and 8b are disposed in the fourth and third recesses 21d and 21c respectively on the vertical projection plane. Accordingly, the first and second pulleys 16 and 17 are disposed above the fourth and third recesses 21d and 21c respectively. Thus, the layout of the drive device 10 and the deflection pulley 19 is also slightly different from that of Embodiment 2. Embodiment 3 is substantially the same as Embodiment 2 in other constructional details.

Although omitted in Embodiments 1 and 2, the car 4 is provided with a pair of car doors 26 for opening and closing a car entrance (two-door center-open type). The components such as the car guide rail 2a, the car guide shoe 20a, and the first rope connecting portion 8a are disposed so as not to interfere with the car doors 26 during their opening movement.

In the elevator apparatus constructed as described above, since the rope connecting portions 8a and 8b are disposed in the recesses 21d and 21c, the installation space for the elevator apparatus in the width direction of the car 4 can further be reduced. As a result, the space for the hoistway can further be reduced.

### Embodiment 4

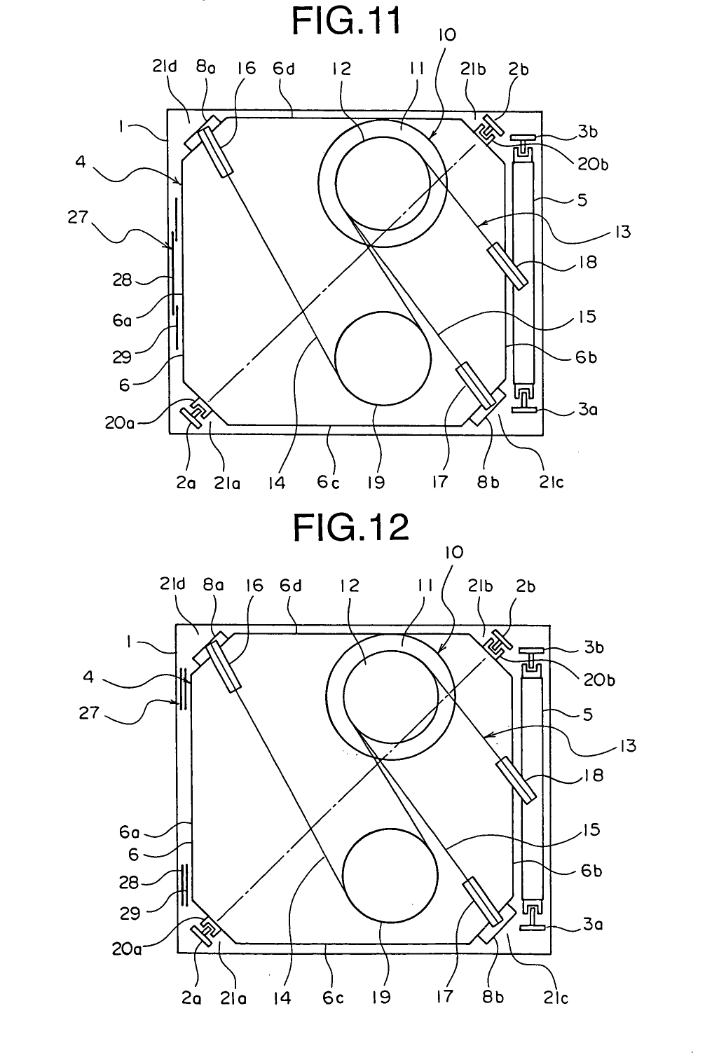

Next, FIG. 11 is a plan view showing an elevator apparatus according to Embodiment 4 of the present invention. FIG. 12 is a plan view showing the elevator apparatus of FIG. 11 in its door-open state. Referring to the figures, the car 4 is mounted with a car door device 27 for opening and closing a car entrance. The car door device 27 has a pair of high-speed car doors 28 and a pair of low-speed car doors 29 (four-door center-open type). Embodiment 4 is substantially the same as Embodiment 3 in other constructional details.

In the elevator apparatus constructed as described above, the two car doors 28 and 29 are lapped over each other when the elevator apparatus is in a door-open state, so that the accommodation space for the car doors 28 and 29 in the door-open state can be reduced. Therefore, without increasing the recesses 21a and 21d located on the front face 6a side of the cage 6, the components accommodated in the recesses 21a and 21d can be easily prevented from interfering with the car door device 27. As a result, a reduction in the floor area of the cage 6 can be restrained.

Although two car doors are used on one side in Embodiment 4, three or more car doors may be used on one side.

Alternatively, a foldable car door, for example, a bellows door may be used. This makes it possible to achieve a reduction in accommodation space in the door-open state.

### Embodiment 5

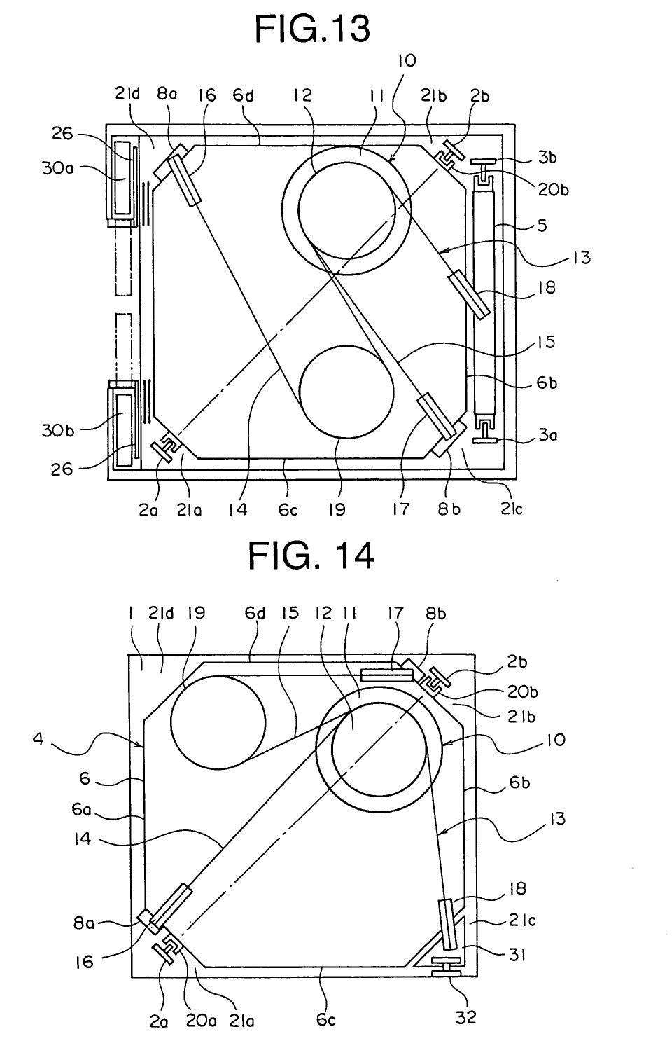

Next, FIG. 13 is a plan view showing an elevator apparatus according to Embodiment 5 of the present invention. Referring to the figure, control panels 30a and 30b are installed in a space between an elevator hall wall and a door pocket portion in which the car doors 26 and elevator hall doors (not shown) are accommodated when the elevator apparatus is in a door-open state. Control components for controlling the operation of the elevator apparatus are accommodated in the control panels 30a and 30b.

As indicated by chain double-dashed lines in the figure, the control panels 30a and 30b can be drawn to an elevator hall entrance through three-side frames during inspection and maintenance.

In the elevator apparatus constructed as described above, the car doors 26 can be easily prevented from interfering with the control panels 30a and 30b. This makes it possible to use one car door 26 on each side and thus suppress an increase in cost.

Although the two control panels 30a and 30b are used in Embodiment 5, they may be integrated into one control panel.

Referring to FIG. 13, components other than the control panels 30a and 30b can also be accommodated in the installation space for the control panels 30a and 30b.

### Embodiment 6

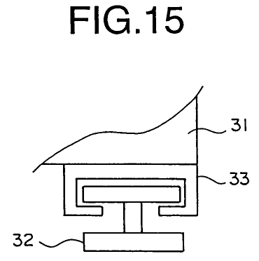

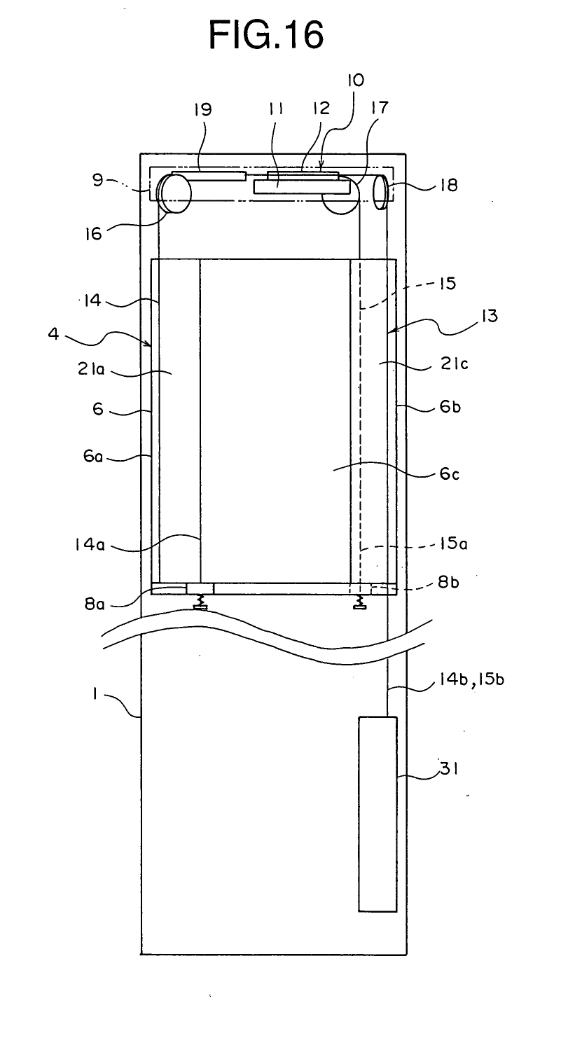

Next, FIG. 14 is a plan view showing an elevator apparatus according to Embodiment 6 of the present invention. FIG. 15 is a plan view showing an essential part of FIG. 14 in an enlarged manner. FIG. 16 is a side view showing the elevator apparatus of FIG. 14.

Referring to the figures, the first and second rope connecting portions 8a and 8b are provided in the first and second recesses 21a and 21b respectively on a vertical projection plane. Accordingly, the first and second pulleys 16 and 17 are disposed above the first and second recesses 21a and 21b respectively. Thus, the layout of the drive device 10 and the deflection pulley 19 is also different from that of Embodiment 2.

Further, a counterweight 31 having a generally triangular cross-section is disposed in a third recess 21c on the vertical projection plane. The counterweight 31 is disposed substantially inside a triangular area (within the third recess 21c) surrounded by an extended straight line of the rear face 6b, an extended straight line of the first side face 6c, and a bottom face (chamfered face) of the third recess 21c on the vertical projection plane.

A counterweight guide rail 32 having an H-shaped cross-section, which guides the counterweight 31 when the counterweight 31 is raised and lowered, is fixed to a hoistway wall facing the first side face 6c. As shown in FIG. 15, a counterweight guide shoe 33 having a C-shaped cross-section, which engages the counterweight guide rail 32, is mounted on the counterweight 31.

Due to engagement of the counterweight guide shoe 33 with the counterweight guide rail 32, the counterweight 31 is restrained from being displaced in the horizontal direction of the car 4.

In the elevator apparatus constructed as described above, since the counterweight 31 is disposed in the third recess 21c on the vertical projection plane, the installation space for the elevator apparatus can be reduced with respect to the width and depth directions of the car 4. As a result, the space for the hoistway can further be reduced.

The counterweight may have a cross-sectional shape other than a triangle.

Although the counterweight 31 is disposed in the third recess 21c in Embodiment 6, it may be disposed in the fourth recess 21d.

Furthermore, two counterweights may be disposed in the third and fourth recesses respectively.

### Embodiment 7

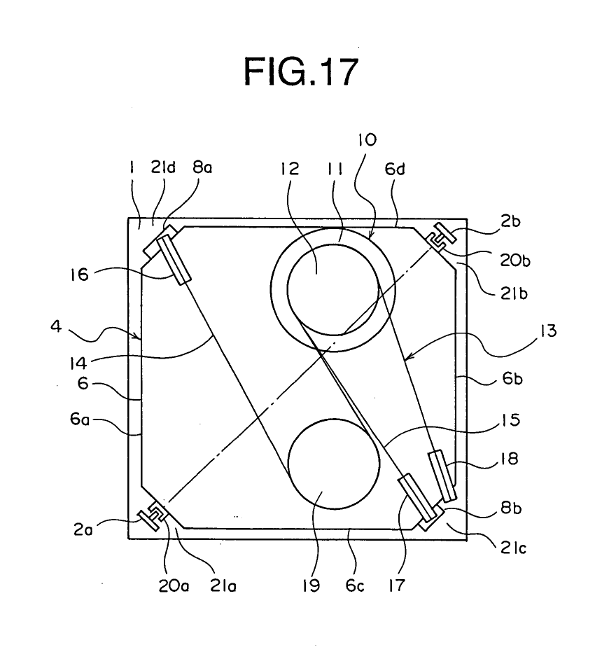

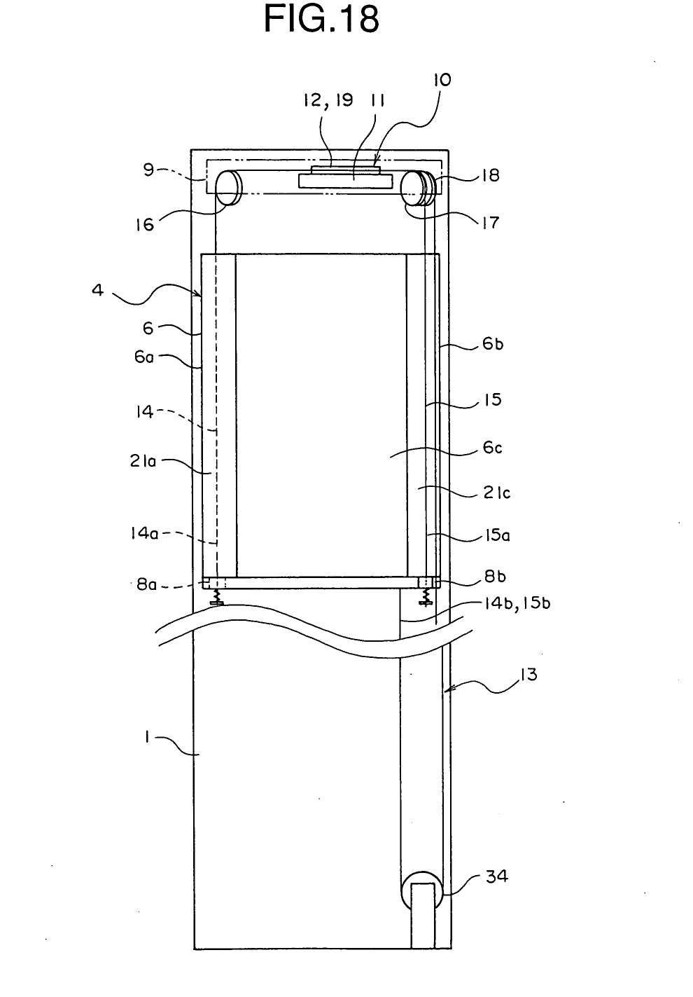

Next, FIG. 17 is a plan view showing an elevator apparatus according to Embodiment 7 of the present invention. FIG. 18 is a side view showing the elevator apparatus of FIG. 17. Referring to the figures, a lower return pulley 34 (FIG. 18) is provided in a lower portion (pit) within the hoistway 1. A main rope group 13 is wound around the lower return pulley 34.

No counterweight is used in Embodiment 7. The third pulley 18 is disposed above the third recess 21c. The main rope group 13 extending downward from the third pulley 18 extends through the third recess 21c and is turned around upwards by the lower return pulley 34. End portions of the main rope group 13, namely, a second end portion 14b of a first main rope 14 and a fourth end portion 15b of a second main rope 15 are connected to the lower portion of the car 4.

Embodiment 7 is substantially the same as Embodiment 3 or 4 in other constructional details.

As described above, the omission of the counterweight makes it possible to reduce the installation space for the elevator apparatus with respect to the width and depth directions of the car 4. As a result, the space for the hoistway can further be reduced.

### Embodiment 8

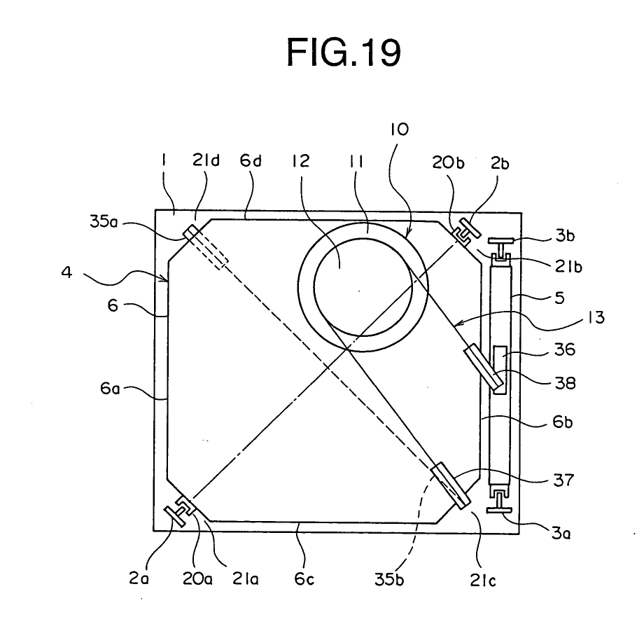

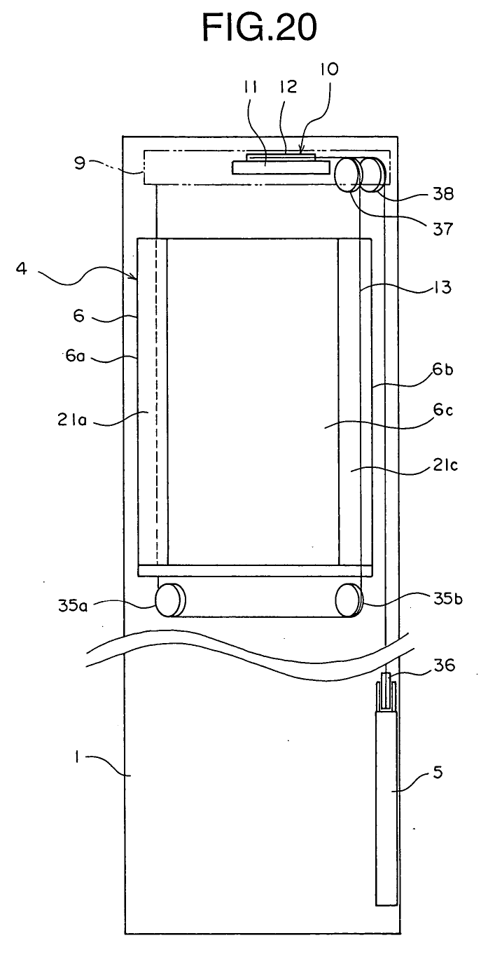

Next, FIG. 19 is a plan view showing an elevator apparatus according to Embodiment 8 of the present invention. FIG. 20 is a side view showing the elevator apparatus of FIG. 19.

Referring to the figures, first and second car suspending pulleys 35a and 35b are provided in the lower portion of the car 4. The first car suspending pulley 35a is so disposed as to be partially located in the fourth recess 21d on the vertical projection plane. The second car suspending pulley 35b is so disposed as to be partially located in the third recess 21c on the vertical projection plane.

A counterweight suspending pulley 36 is provided in the upper portion of the counterweight 5. The main rope group 13 including a plurality of main ropes is wound around the car suspending pulleys 35a and 35b and the counterweight suspending pulley 36.

A car-side return pulley 37 for guiding the main rope group 13 from the drive sheave 12 to the car suspending pulley 35b, and a counterweight-side return pulley 38 for guiding the main rope group 13 from the drive sheave 12 to the counterweight suspending pulley 36 are provided in the upper portion of the hoistway 1. The return pulleys 37 and 38 have horizontal rotating shafts.

A first end portion (car-side end portion) and a second end portion (counterweight-side end portion) of the main rope group 13 are connected to the support frame 9. Further, the main rope group 13 is wound, sequentially from the side of the first end portion, around the car suspending pulleys 35a and 35b, the car-side return pulley 37, the drive sheave 12, the counterweight-side return pulley 38, and the counterweight suspending pulley 36. That is, in Embodiment 8, the car 4 and the counterweight 5 are suspended within the hoistway 1 according to a 2:1 roping method by means of the main rope group 13.

Further, the main rope group 13 partially extends through the third and fourth recesses 21c and 21d. Embodiment 8 is substantially the same as Embodiment 3 or 4 in other constructional details. Further, the first and second elevator units 101 and 102 are basically identical in construction.

Also in the elevator apparatus employing the 2:1 roping method as described above, since the car guide shoes 20a and 20b and the car guide rails 2a and 2b are disposed in the recesses 21a and 21b provided in the cage 6, the installation space for the elevator apparatus in the width direction of the car 4 can be reduced. As a result, the space for the hoistway can further be reduced.

Further, the car suspending pulleys 35a and 35b are partially disposed in the recesses 21d and 21c respectively on the vertical projection plane, and the main rope group 13 extends through the recesses 21d and 21c. This also makes it possible to reduce the installation space for the elevator apparatus in the width direction of the car 4 and further reduce the space for the hoistway.

### Embodiment 9

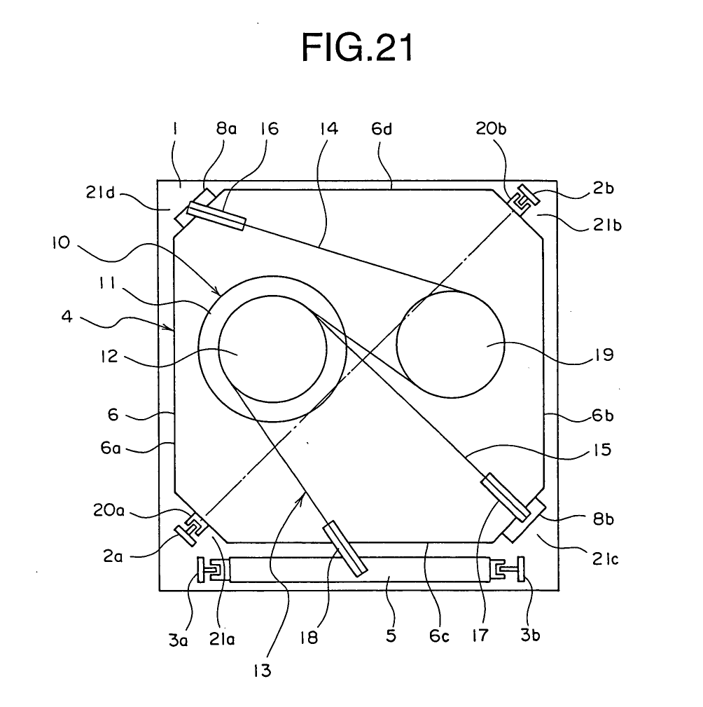

Next, FIG. 21 is a plan view showing an elevator apparatus according to Embodiment 9 of the present invention. Referring to the figure, the counterweight 5 is disposed beside the car 4 so as to face the first side face 6c when being located at the same height as the car 4.

Even in the elevator apparatus with such a layout, since the car guide shoes 20a and 20b and the car guide rails 2a and 2b are disposed in the recesses 21a and 21b provided in the cage 6, the installation space for the elevator apparatus in the width direction of the car 4 can be reduced. As a result, the space for the hoistway can further be reduced.

Further, since the rope connecting portions 8a and 8b are disposed in the recesses 21d and 21c respectively, the installation space for the elevator apparatus in the width direction of the car 4 can further be reduced. As a result, the space for the hoistway can further be reduced.

### Embodiment 10

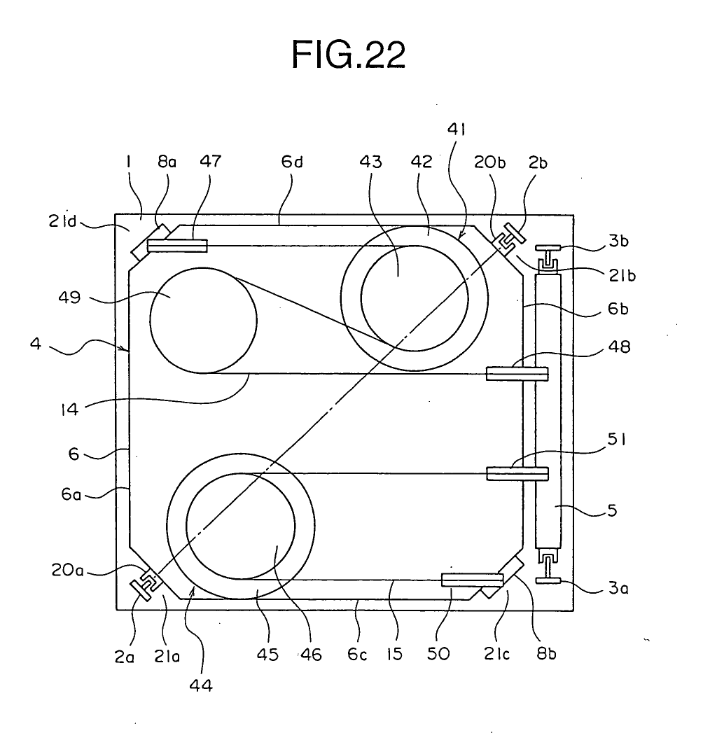

Next, FIG. 22 is a plan view showing an elevator apparatus according to Embodiment 10 of the present invention. Referring to the figure, first and second drive devices 41 and 44 are provided in an upper portion within the hoistway 1a. The first drive device 41 has a first drive device main body 42 including a motor and a brake, and a first drive sheave 43 rotated by the first drive device main body 42. The second drive device 44 has a second drive device main body 45 including a motor and a brake, and a second drive sheave 46 rotated by the second drive device main body 45.

In this example, the drive sheaves 43 and 46 are disposed on the drive device main bodies 42 and 45 respectively. Further, the drive devices 41 and 44 are disposed horizontally (or substantially horizontally) such that rotating shafts of the drive sheaves 43 and 46 extend vertically (or substantially vertically). Furthermore, thin hoisting machines having an axial dimension smaller than a radial dimension of the drive sheaves 43 and 46 or a radial dimension of the drive device main bodies 42 and 45 are employed as the drive devices 41 and 44.

In addition, the drive devices 41 and 44 entirely or substantially entirely overlap each other on the vertical projection plane. That is, the drive devices 41 and 44 are disposed directly above the car 4. More specifically, the drive devices 41 and 44 are disposed at the diagonal positions of the car 4 on the vertical projection plane.

A plurality of first main ropes 14 (only one of which is shown in the figure) for suspending the car 4 and the counterweight 5 within the hoistway 1 are wound around the first drive sheave 43. A plurality of second main ropes 15 (only one of which is shown in the figure) for suspending the car 4 and the counterweight 5 within the hoistway 1 are wound around the second drive sheave 46.

The car 4 and the counterweight 5 are suspended according to the 1:1 roping method by means of the main ropes 14 and 15.

A first car-side return pulley 47 for guiding the first main ropes 14 to the first rope connecting portion 8a, a first counterweight-side return pulley 48 for guiding the first main ropes 14 to the counterweight 5, a deflection pulley 49 for guiding the first main ropes 14 from the first drive sheave 43 to the first counterweight-side return pulley 48, a second car-side return pulley 50 for guiding the second main ropes 15 to the second rope connecting portion 8b, and a second counterweight-side return pulley 51 for guiding the second main ropes 15 to the counterweight 5 are provided in the upper portion within the hoistway 1a.

The first car-side return pulley 47, the first counterweight-side return pulley 48, the second car-side return pulley 50, and the second counterweight-side return pulley 51 are disposed such that their rotating shafts extend horizontally. The deflection pulley 49 is disposed such that its rotating shaft extends vertically or substantially vertically.

The portions of the first main ropes 14 between the first drive sheave 43 and the first car-side return pulley 47, the portions of the first main ropes 14 between the deflection pulley 49 and the first counterweight-side return pulley 48, the portions of the second main ropes 15 between the second drive sheave 46 and the second car-side return pulley 50, and the portions of the second main ropes 15 between the second drive sheave 46 and the second counterweight-side return pulley 51 are parallel to one another and parallel to the depth direction of the car 4.

A second end portion (counterweight-side end portion) of each first main rope 14 and a fourth end portion (counterweight-side end portion) of each second main rope 15 are spaced apart from each other in the width direction of the counterweight 5 and connected to the upper portion of the counterweight 5.

In the elevator apparatus constructed as described above, since the car 4 and the counterweight 5 are raised and lowered by driving forces of the first and second drive devices 41 and 43, a large passenger capacity can be ensured.

As described above, even in the case where the two drive devices 41 and 43 are employed, the car guide shoes 20a and 20b and the car guide rails 2a and 2b are disposed in the recesses 21a and 21b provided in the cage 6. Thus, the installation space for the elevator apparatus in the width direction of the car 4 can be reduced. As a result, the space for the hoistway can further be reduced.

Further, since the rope connecting portions 8a and 8b are disposed in the recesses 21d and 21c, the installation space for the elevator apparatus in the width direction of the car 4 can further be reduced. As a result, the space for the hoistway can further be reduced.

### Embodiment 11

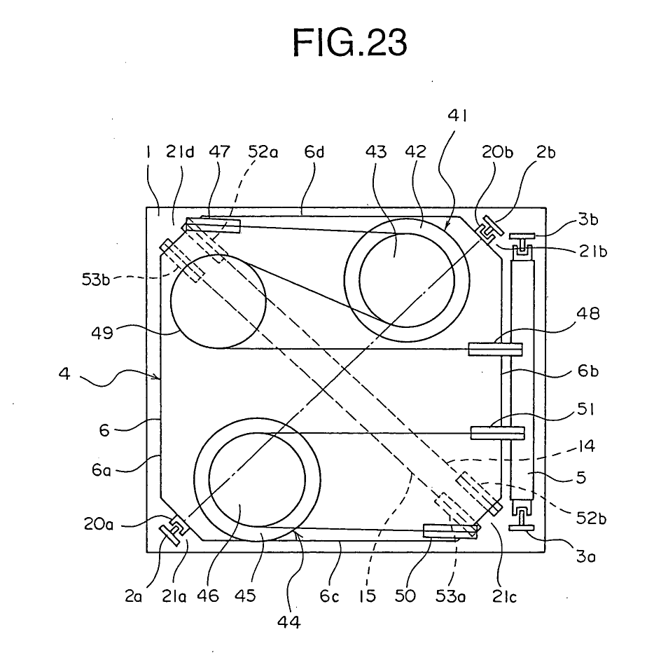

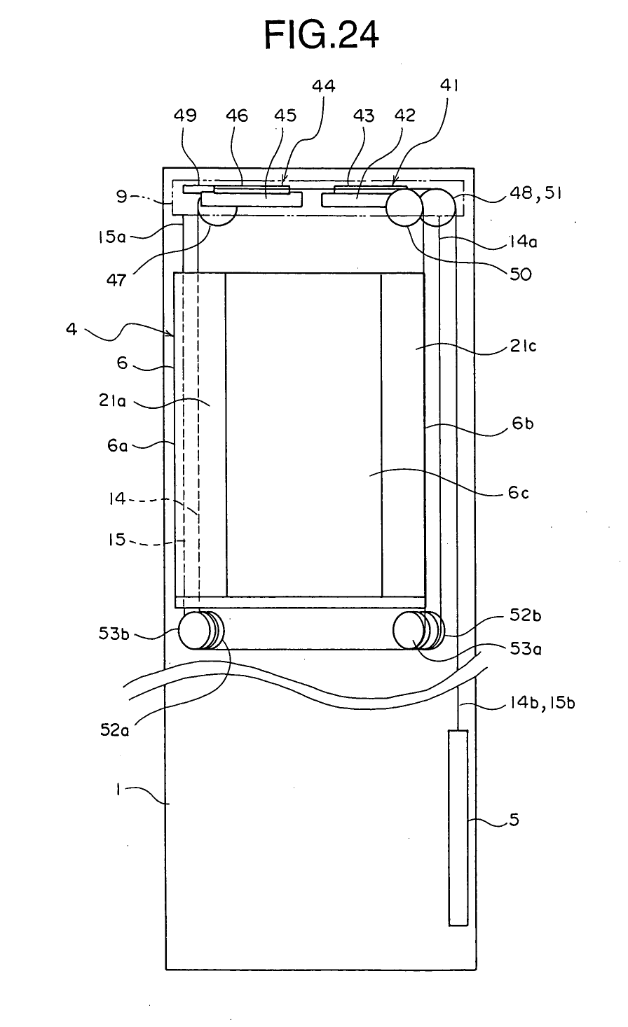

Next, FIG. 23 is a plan view showing an elevator apparatus according to Embodiment 11 of the present invention. FIG. 24 is a side view showing the elevator apparatus of FIG. 23.

Referring to the figures, a pair of first car suspending pulleys 52a and 52b around which the first main rope 14 is wound and a pair of second car suspending pulleys 53a and 53b around which the second main rope 15 is wound are provided in the lower portion of the car 4.

The first car suspending pulley 52a and the second car suspending pulley 53a are disposed so as to be partially located in the fourth recess 21d on the vertical projection plane. The first car suspending pulley 52b and the second car suspending pulley 53b are disposed so as to be partially located in the third recess 21c on the vertical projection plane.

A portion of the first main rope 14 between the first car suspending pulleys 52a and 52b and a portion of the second main rope 15 between the second car suspending pulleys 53a and 53b are parallel to each other.

The first end portion 14a of the first main rope 14 and the third end portion 15a of the second main rope 15 are connected to the support frame 9.

The first main rope 14 is wound, sequentially from the first end portion 14a side, around the first car suspending pulley 52b, the first car suspending pulley 52a, a first car-side return pulley 47, a first drive sheave 43, a deflection pulley 49, and a first counterweight-side return pulley 48.

The second main rope 15 is wound, sequentially from the third end portion 15a side, around the second car suspending pulley 53b, the second car suspending pulley 53a, a second car-side return pulley 50, a second drive sheave 46, and a second counterweight-side return pulley 51.

The car 4 is suspended within the hoistway 1 according to a 2:1 roping method by means of the main ropes 14 and 15. The counterweight 5 is suspended within the hoistway 1 according to a 1:1 roping method by means of the main ropes 14 and 15.

Embodiment 11 is the same as Embodiment 10 in other constructional details.

As described above, even in the elevator apparatus having roping ratios different between on the car 4 side and on the counterweight 5 side, since the car guide shoes 20a and 20b and the car guide rails 2a and 2b are disposed in the recesses 21a and 21b provided in the cage 6, the installation space for the elevator apparatus in the width direction of the car 4 can be reduced. As a result, the space for the hoistway can further be reduced.

Further, the car suspending pulleys 52a, 52b, 53a, and 53b are partially disposed in the recesses 21d and 21c on the vertical projection plane, and the main ropes 14 and 15 extend through the recesses 21d and 21c. Therefore, this also makes it possible to reduce the installation space for the elevator apparatus in the width direction of the car 4 and achieve a further reduction in the space for the hoistway.

### Embodiment 12

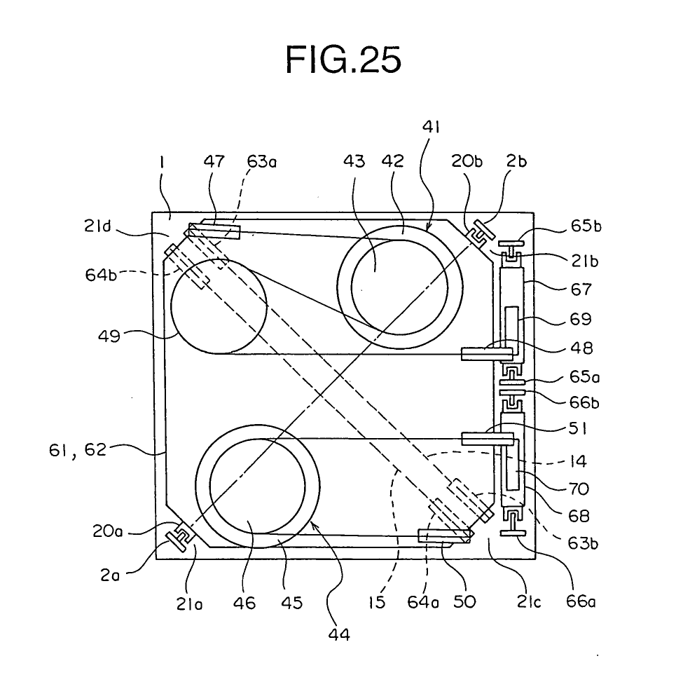

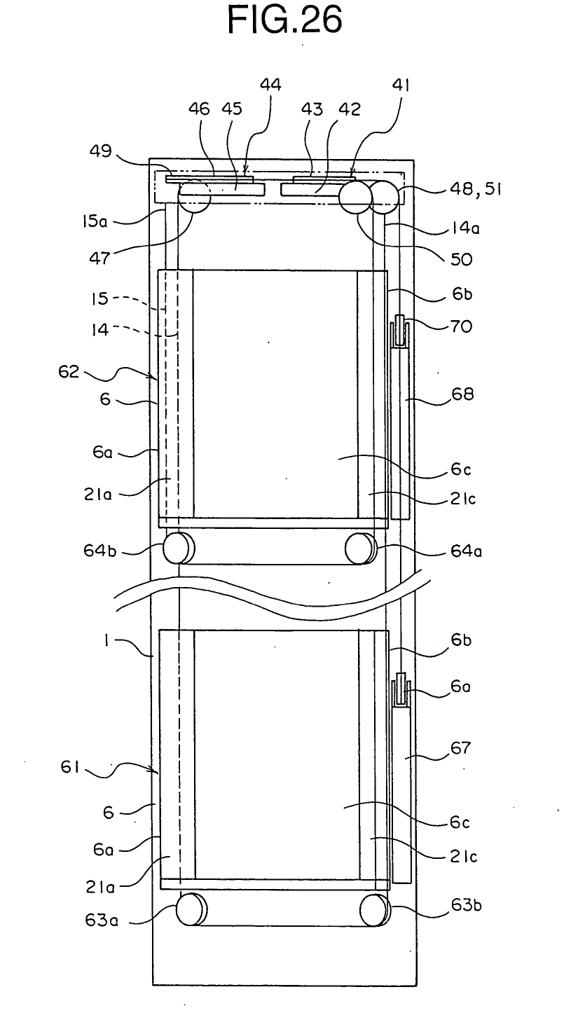

Next, FIG. 25 is a plan view showing an elevator apparatus according to Embodiment 12 of the present invention. FIG. 26 is a side view showing the elevator apparatus of FIG. 25.

Referring to the figures, a first car (lower car) 61 and a second car (upper car) 62 that is raised and lowered above the first car 61 are provided within the hoistway 1. Each of the first and second cars 61 and 62 has the cage 6 as shown in Embodiments 2 to 11.

A pair of first car suspending pulleys 63a and 63b are provided on a lower portion of the first car 61. A pair of second car suspending pulleys 64a and 64b are provided on a lower portion of the second car 62.

A pair of first counterweight guide rails 65a and 65b and a pair of second counterweight guide rails 66a and 66b are installed within the hoistway 1. The first counterweight guide rails 65a and 65b and the second counterweight guide rails 66a and 66b are disposed such that their centerlines coincide with each other on a straight line parallel to the width direction of the car 4 on the vertical projection plane.

A first counterweight 67 that is raised and lowered while being guided by the first counterweight guide rails 65a and 65b, and a second counterweight 68 that is raised and lowered while being guided by the second counterweight guide rails 66a and 66b are provided within the hoistway 1. The first and second counterweights 67 and 68 are disposed behind the car 4 so as to face the rear face 6b when being located at the same height as the car 4 respectively.

A first counterweight suspending pulley 69 is provided on an upper portion of the first counterweight 67. A second counterweight suspending pulley 70 is provided on an upper portion of the second counterweight 68.

The first car 61 and the first counterweight 67 are suspended within the hoistway 1 according to the 2:1 roping method by means of the first main rope 14. The second car 62 and the second counterweight 68 are suspended within the hoistway 1 according to the 2:1 roping method by means of the second main rope 15.

The opposite end portions of the first main rope 14 and the opposite end portions of the second main rope 15 are connected to the support frame 9.

The first main rope 14 is wound, sequentially from the first end portion 14a side, around the first car suspending pulley 63b, the first car suspending pulley 63a, the first car-side return pulley 47, the first drive sheave 43, the deflection pulley 49, the first counterweight-side return pulley 48, and the first counterweight suspending pulley 69.

The second main rope 15 is wound, sequentially from the third end portion 15a side, around the second car suspending pulley 64b, the second car suspending pulley 64a, the second car-side return pulley 50, the second drive sheave 46, the second counterweight-side return pulley 51, and the second counterweight suspending pulley 70.

The first car 61 and the first counterweight 67 are raised and lowered by a driving force of the first drive device 41. The second car 62 and the second counterweight 68 are raised and lowered by a driving force of the second drive device 44.

The car suspending pulleys 63a, 63b, 64a, and 64b are disposed so as to be partially located in the recesses 21d and 21c on the vertical projection plane. Further, the main ropes 14 and 15 extend through the third and fourth recesses 21c and 21d. A portion of the first main rope 14 between the first car suspending pulleys 63a and 63b and a portion of the second main rope 15 between the second car suspending pulleys 64a and 64b are parallel to each other on the vertical projection plane.

A portion of the first main rope 14 between the first drive sheave 43 and the first car-side return pulley 47, a portion of the first main rope 14 between the deflection pulley 49 and the first counterweight-side return pulley 48, a portion of the second main rope 15 between the second drive sheave 46 and the second car-side return pulley 50, and a portion of the second main rope 15 between the second drive sheave 46 and the second counterweight-side return pulley 51 are parallel to one another and parallel to the depth direction of the car 4.

As described above, even in the elevator apparatus having the plurality of cars 61 and 62 disposed within the single hoistway 1, that is, a so-called one-shaft multi-car-type elevator apparatus, since the car guide shoes 20a and 20b and the car guide rails 2a and 2b are disposed in the recesses 21a and 21b provided in the cage 6, the installation space for the elevator apparatus in the width direction of the car 4 can be reduced. As a result, the space for the hoistway can further be reduced.

Further, the car suspending pulleys 63a, 63b, 64a, and 64b are partially disposed in the recesses 21d and 21c on the vertical projection plane, and the main ropes 14 and 15 extend through the recesses 21d and 21c. Therefore, this also makes it possible to reduce the installation space for the elevator apparatus in the width direction of the car 4. As a result, the space for the hoistway can further be reduced.

In the aforementioned examples, the elevator apparatus according to the 1:1 roping method and the elevator apparatus according to the 2:1 roping method are illustrated. However, the roping method is not limited to those.

Further, in the aforementioned examples, the machine-room-less elevator apparatus having the drive device disposed within the hoistway is described. However, the present invention is also applicable to an elevator apparatus having a machine room in which a drive device and a control panel are installed.

Furthermore, the present invention makes it possible to reduce the space for the hoistway and is therefore particularly advantageous to an elevator apparatus having a structure in which neither a drive device nor a control panel is disposed between a car and a wall of a hoistway.

Still further, in the aforementioned examples, the drive device is disposed such that the rotating shaft of the drive sheave extends vertically or almost vertically. However, the disposition of the drive device is not limited to this. For instance, the drive device may be disposed such that the rotating shaft of the drive sheave extends horizontally.

Further, in the aforementioned examples, the drive device is disposed such that the drive sheave is located in the upper portion of the drive device main body. On the contrary, however, the drive device may also be disposed such that the drive sheave is located in the lower portion of the drive device main body.

Furthermore, in the aforementioned examples, the drive device is disposed in the upper portion of the hoistway. However, the position of the drive device is not limited to this. For instance, the drive device may also be disposed in the lower portion of the hoistway. Further, the present invention is also applicable to a self-propelled elevator apparatus having a drive device mounted in an upper or lower portion of a car.

Still further, for example, ropes having a circular cross-section, belt-like ropes, or the like can be employed as the main ropes.

Further, for example, steel ropes, resin-coated ropes having an outer layer coating member made of a high-friction resin material provided on an outer periphery portion thereof, or the like can be employed as the main ropes. The use of resin-coated ropes makes it possible to ensure a large traction force at a small winding angle. Further, the resin-coated ropes can enhance flexibility more than simple steel ropes and the diameter of the drive sheave can thus be reduced.

In addition, the components (drive device, return pulley, deflection pulley, and the like) disposed in the upper portion of the hoistway 1 may be unitized by being mounted on a common support frame.

Still further, in the aforementioned examples, all the car guide shoes are disposed in the recesses. It may also be appropriate, however, that only the car guide shoes on one side are disposed in the recesses.

1. An elevator apparatus comprising:
a car having a wall portion, for being raised and lowered within a hoistway;
a car guide rail installed within the hoistway, for guiding the car when the car is raised and lowered; and
a car guide shoe mounted on the car, for engaging with the car guide rail,
wherein the wall portion is provided with a recess, and the car guide shoe is at least partially disposed in the recess on a vertical projection plane.

2. The elevator apparatus according to claim 1, wherein:
the wall portion has a front face provided with a car entrance, a rear face facing the front face, a first side face, and a second side face facing the first side face;
the recess includes a first recess provided in a corner portion between the front face and the first side face, and a second recess provided in a corner portion between the rear face and the second side face; and
the car guide shoe includes a first car guide shoe provided in the first recess, and a second car guide shoe provided in the second recess.

3. The elevator apparatus according to claim 2, wherein:
the first car guide shoe is disposed substantially inside a region surrounded by an extended straight line of the front face, an extended straight line of the first side face, and a bottom face of the first recess on the vertical projection plane; and
the second car guide shoe is disposed substantially inside a region surrounded by an extended straight line of the rear face, an extended straight line of the second side face, and a bottom face of the second recess on the vertical projection plane.

4. The elevator apparatus according to claim 2, wherein:
the recess further includes a third recess provided in a corner portion between the rear face and the first side face, and a fourth recess provided in a corner portion between the front face and the second side face;
the car is provided with a first suspending member connecting portion and a second suspending member connecting portion to which a main suspending member for suspending the car is connected respectively; and
the first suspending member connecting portion and the second suspending member connecting portion are provided in the third recess and the fourth recess respectively on the vertical projection plane.

5. The elevator apparatus according to claim 2, further comprising a counterweight that is raised and lowered within the hoistway, wherein:
the recess further includes at least one of a third recess provided in a corner portion between the rear face and the first side face, and a fourth recess provided in a corner portion between the front face and the second side face; and
the counterweight is disposed in at least one of the third recess and the fourth recess on the vertical projection plane.

6. The elevator apparatus according to claim 2, wherein:
the recess further includes a third recess provided in a corner portion between the rear face and the first side face, and a fourth recess provided in a corner portion between the front face and the second side face;
the car is provided on its lower portion with a first car suspending pulley and a second car suspending pulley;
main suspending member for suspending the car are wound around the first car suspending pulley and the second car suspending pulley; and
the first car suspending pulley and the second car suspending pulley are disposed to be partially located in the third recess and the fourth recess respectively on the vertical projection plane.

7. The elevator apparatus according to claim 1, wherein the recess is continuously provided along a direction in which the car is raised and lowered.

8. The elevator apparatus according to claim 1, wherein, in its cross-section, 80% or more of each of the car guide shoes is accommodated in the recess.

9. The elevator apparatus according to claim 1, wherein:
the wall portion has a front face provided with a car entrance, a rear face facing the front face, a first side face, and a second side face facing the first side face; and
the recess includes a first recess provided in the first side face, and a second recess provided in the second side face.

10. The elevator apparatus according to claim 9, wherein:
the car guide rail includes a first car guide rail opposed to the first recess, and a second car guide rail opposed to the second recess;
the car is provided on the first side face side with a first suspending member connecting portion to which a first main suspending member for suspending the car is connected;
the car is provided on the second side face side with a second suspending member connecting portion to which a second main suspending member for suspending the car is connected; and
the first car guide rail and the second car guide rail have a pitch between car guide rail rear faces which is set equal to or smaller than a car suspension pitch defined by the first main suspending member and the second main suspending member.

11. The elevator apparatus according to claim 1, wherein the car guide rail is at least partially disposed in the recess on the vertical projection plane.

12. The elevator apparatus according to claim 1, wherein the recess is a chamfered portion provided in a corner portion of the car.

13. The elevator apparatus according to claim 1, wherein:
the car guide rail includes a first car guide rail and a second car guide rail; and
the first car guide rail and the second car guide rail have centerlines that are parallel to each other on the vertical projection plane.

14. The elevator apparatus according to claim 1, wherein:
the car guide rail includes a first car guide rail and a second car guide rail; and
the first car guide rail and the second car guide rail have centerlines that are located on an identical straight line.

15. The elevator apparatus according to claim 1, wherein:
the car is provided with a suspending member connecting portion to which a main suspending member for suspending the car is connected; and
the suspending member connecting portion is disposed in the recess common to the car guide shoe on the vertical projection plane.

16. The elevator apparatus according to claim 1, further comprising:
a drive device provided in an upper portion of the hoistway and having a drive sheave around which a main suspending member for suspending the car is wound, for raising and lowering the car via the main suspending member, wherein
the drive device is disposed so that a rotating shaft of the drive sheave extends vertically or substantially vertically.

17. The elevator apparatus according to claim 1, wherein:
the car is provided with a car door device for opening and closing a car entrance; and
the car door device has a plurality of car doors that overlap one another in a door-open state.

18. An elevator apparatus comprising:
a drive device having a drive sheave;
a first main suspending member and a second main suspending member wound around the drive sheave;
a car having a first suspending member connecting portion to which the first main suspending member is connected and a second suspending member connecting portion to which the second main suspending member is connected, for being raised and lowered within a hoistway through a driving force of the drive device; and
a first car guide rail and a second car guide rail installed within the hoistway, for guiding the car when the car is raised and lowered,
wherein the first car guide rail and the second car guide rail have a pitch between car guide rail rear faces which is set equal to or smaller than a car suspension pitch defined by the first main suspending member and the second main suspending member, in a width direction of the car.

19. An elevator apparatus comprising:
a car for being raised and lowered within a hoistway;
a pair of car guide rails installed within the hoistway, for guiding the car when the car is raised and lowered; and
a plurality of car guide shoes installed in the car, for engaging with the car guide rails
wherein:
the car has chamfered portions facing each other, the chamfered portions being formed at diagonally located corner portions of the car;
the car guide rails are installed to face the chamfered portions respectively; and
the car guide shoes are disposed in the chamfered portions respectively.

20. An elevator apparatus comprising:
a car having a wall portion, for being raised and lowered within a hoistway;
a car guide rail installed within the hoistway, for guiding the car when the car is raised and lowered; and
an safety device installed in the car, for engaging with the car guide rail to stop the car as an emergency measure,
wherein the wall portion is provided with a recess, and the safety device is at least partially disposed in the recess on a vertical projection plane.
